(19) United States
(12) Patent Application Publication
(10) Pub. No.: US 2003/0094498 A1
(43) Pub. Date: May 22, 2003

(54) Apparatus to assist magnetic strip readers

(76) Inventors: Ronald T. Jones, Craig, CO (US); Timothy A. Richardson, Eugene, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/992,727

(22) Filed: Nov. 16, 2001

(51) Int. Cl. G06K 19/00

(52) U.S. Cl. 235/487

(57) ABSTRACT

An apparatus and method for enhancing the ability of a magnetic strip reader to read magnetic strips on cards such as credit cards, debit cards, identification cards, and key cards. When a magnetic strip card reader fails to read the magnetic strip on the item, the ability of the magnetic strip reader to read the magnetic strip is enhanced by placing the item within the card holder of the present invention and then re-swiping the item through the magnetic strip reader. The card holder is preferably made from a film of high density polyethylene having a thickness of between 0.0004″ and 0.0008″.

### CROSS-REFERENCE TO RELATED APPLICATIONS

None.

### STATEMENT REGARDING FEDERALLY SPONSORED RESEARCH OR

### DEVELOPMENT

Not Applicable.

### BACKGROUND OF THE INVENTION

1. Technical Background

The present invention relates to an apparatus for assisting magnetic card readers to read the magnetic strip on various cards such as credit cards, debit cards, identification cards, key cards

2. Description of Related Art

Currently, cards having a magnetic strip are used by swiping or passing the magnetic strip of the card through a card reader. The card reader reads the card number or other information on the card. In the instance of credit and debit cards, use of the card reader avoids the need for the cashier to enter in the card number; reduces entry error by the cashiers; and, shortens the time required for a credit card transaction. A common problem, however, is that the magnetic strips become dirty, or for some other reason, become unreadable by the reader. When this happens, the cashier must enter the card number by hand. This introduces the possibility of entry error by the cashier and increases the time required for a credit/debit card transaction. Cashier errors can cause charges to be applied to somebody else's card.

Various types of card holders exist in the market place. These credit card holders are generally intended to protect the credit card or to protect the magnetic strip on a credit card. While such credit card holders may prevent or reduce the possibility of a credit card's magnetic strip from becoming unreadable, they do not help a card reader when the magnetic strip is unreadable.

### SUMMARY OF THE INVENTION

The present invention provides a credit card holder that does more than simply protect a card having a magnetic strip or the magnetic strip on the card. Instead, the present invention enhances the ability of a magnetic strip reader to actually read the magnetic strip on the card.

In virtually every retail establishment, there is a magnetic strip reader which is used to read the information about a credit card which has been encoded onto a magnetic strip bonded directly to the credit card. When a purchase is made with a credit card, the customer gives the credit card to the cashier who then swipes the card through the slit in the magnetic strip or card reader. While this process usually results in the magnetic strip reader obtaining the information encoded on the magnetic strip of the credit card, very often, the magnetic strip fails to read the information on the magnetic strip on the first pass. The cashier must then repeat the process by re-swiping the credit card through the slit in the magnetic card reader. In many cases, the second swiping of the credit card also fails. In some cases, the magnetic strip reader is simply unable to read the magnetic strip on the credit card regardless of how many times the credit card is swiped through the magnetic strip reader. The inability of the magnetic strip reader to read the encoded information on the magnetic strip results in the delay in processing the customer's purchasing transaction, thus making the cashier inefficient and the customers frustrated with the retail establishment's procedures.

However, when the previously unreadable credit card is placed within the card holder of the present invention and then passed through the magnetic strip reader while in the holder, the ability of the magnetic strip reader is enhanced, usually allowing the magnetic strip reader to read the information encoded on the magnetic strip of the credit card on the first swipe. Thus, rather than exacerbate the delay problem by repeatedly swiping a credit card through the magnetic strip reader without success, after the first failure to read the magnetic strip, the cashier or customer simply inserts the credit card into the card holder of the present invention and then re-swipes the card through the magnetic strip reader while the card is in the holder. The present invention makes it very likely that the second swipe of the credit card will result in a successful reading of the magnetic strip by the magnetic strip reader.

Briefly stated, the card holder, in a preferred embodiment, comprises front and back panels joined together along at least two edges to form an opening between the front and back panels through which the card can pass. At least a portion of the front panel (against which the magnetic strip is positioned when the card is inserted in the card holder) is made from a film of high density polyethylene having a thickness of about 0.0004″ to about 0.0008″ (about 0.4-0.8 mils). This portion of the front panel is sized and positioned such that, when the card is inserted in the holder, the magnetic strip of the card will be in register with the film portion of the holder. Preferably, the film portion extends from the bottom of the card to a point above the magnetic strip of the card, when the card is inserted in the holder.

Where the front portion is preferably made from the film, the back portion can be made from a different plastic. However, preferably, both the front and back panels are made from the thin film. In this instance, the front and back panels are provided with an upper thicker section, which is sufficiently thick to rigidize the holder enough to enable the holder to be opened by squeezing together opposite sides of the second section. For example, the upper section can have a thickness of about 0.004″ to about 0.008″ (4-8 mils).

### BRIEF DESCRIPTION OF THE DRAWINGS

FIG. 1 is a plan view of one illustrative embodiment of a card holder of the present invention which assists magnetic strip readers in reading information on the magnetic strip of a card; the card holder being shown having a card received therein;

FIG. 2 is a cross-sectional view of the card holder;

FIG. 3 is a perspective view of showing the use of the card holder in a common magnetic strip reader installation.

Corresponding reference characters indicate corresponding parts throughout the several views of the drawings.

### DETAILED DESCRIPTION OF THE INVENTION

Although the description of the present invention shows an embodiment of the invention based upon reading the magnetic strip on a credit card, it will be appreciated that the scope of the invention includes the use of the present invention to enhance the ability to read magnetic strips on any card which has a magnetic strip which can be read by a magnetic strip reader. Such cards include, but are not limited to, credit cards, debit cards, identification cards, and hotel key cards. Again, this list is illustrative only, and is not intended to be limiting.

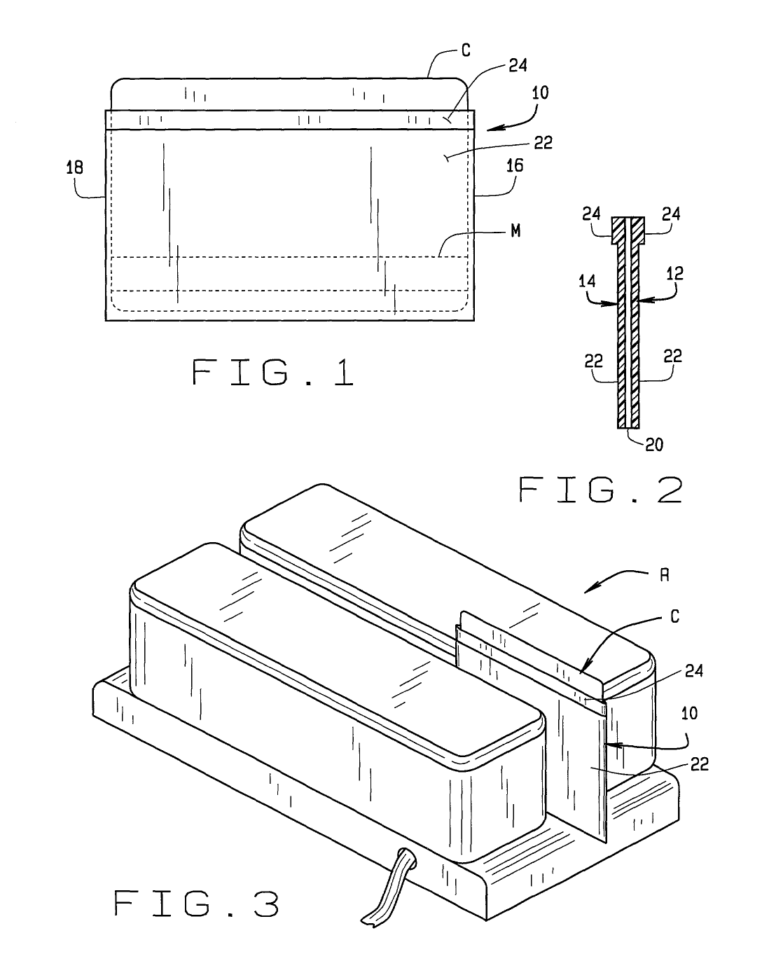

An apparatus, in the form of a card holder or envelope 10, to enhance magnetic strip readers is shown generally in FIGS. 1 and 2. The card holder 10 has a front panel 12 and a back panel 14. The front and back panels are joined at their sides by seams 16 and 18, and at their bottoms by a seam 20. As noted below, the panels are made from plastic, and hence, can be joined by ultrasonic welding, gluing, or any other conventional joining method.

The card holder 10 is sized to receive a standard sized card C. The card holder 10 is slightly larger in width than the card C so that the card can be slid into, and removed from, the card holder easily. A standard credit card has a width of about 3.3″. Thus, the card holder 10 can have a width, for example, of about 3.5″ to about 4″. The card holder 10 need only be tall enough to cover the magnetic strip M of the card C. Thus, for example, the card holder 10 can have a height of about 1.5″ to about 1.8″ which is less than the height of the card C. Providing the card holder 10 with a height less than the card C will facilitate insertion and removal of the card C into the holder 10.

Preferably, at least a portion of the front panel 12 comprises a plastic film, such as a high density polyethylene (HDPE) film. The HDPE film has a thickness sufficient to allow the reader to read the magnetic strip through the film. Preferably the HDPE film portion of the front panel 12 has a thickness of from about 0.4 to about 0.8 mils (about 0.0004″ to about 0.0008″). The HDPE film portion of the front panel 12 is sized such that the magnetic strip M of the card C is in register with the HDPE portion of the panel 12 when the card is inserted in the holder 10. The HDPE film could be formed as a “window” on the front panel 12. However, preferably, the HDPE film extends from the bottom of the card (i.e., from the bottom of the card holder 10) to a point above the magnetic strip of the card, when the card is received in the card holder. Hence, the HDPE film need only have a height of about ¾″ to about 1″, but can be more, if desired. Because the magnetic strip extends the full length of the card, the film extends the full length of the panel 12.

The back panel 14 can be made of a stronger or thicker plastic to thereby strengthen the card holder 10. However, to facilitate manufacturing of the holder, the back panel 14 is preferably made of the same material as the front panel 12. In fact, the front and back panels 12 and 14 are substantially identical in shape. Each panel has a lower section 22 and an upper section 24. The lower sections 22 are thinner than the upper sections 24, having a thickness of about 0.4-0.8 mils, as noted above. The height of the lower section is has a height greater than the depth of the slot of the card reader. Thus, the card holder lower section has a height sufficient to extend from the bottom of the card C to a point above the card's magnetic strip M. As noted above, the lower section 22 of the panels are preferable at least about ¾″ to about 1″ in height. The panel upper sections 24 make up the rest of the height of the panels.

The thicker upper section 24 is provided to give some rigidity to the card holder 10 to facilitate opening of the holder 10 to insert the card C in the holder. As can be seen in FIG. 2, the upper section 24 can define a lip. As noted above, this lip provides for an area of the holder that is thicker and hence more rigid. This allows for the card holder 10 to be opened by squeezing the seams 16 and 18 together at the card holder upper section 24. Although shown as a lip, the upper section 24 can be larger if desired. The upper section 24 is preferably made from the same material as the lower section 22, however, via conventional co-molding procedures, the upper section 24 can be made of other materials as well. The thickness of the upper section can be about 4 to about 8 mils (about 0.004″ to about 0.008″) in width.

Use of the card holder is shown in FIG. 3. If a card is unreadable, the card C is simply inserted in the card holder 10 with the magnetic strip M facing, and in register with, the HDPE film of the panel 12. The card in the card holder is then passed or swiped through the card reader R. Unexpectedly, for a card C in which the magnetic strip is unreadable, inserting the card C in the card holder 10 with the magnetic strip facing the HDPE film, and passing the card through the card reader while in the card holder, enables the reader R to read the magnetic strip M. It will be appreciated, that while the use of the card holder enhances the readability of otherwise unreadable magnetic strips, it will not be useful in situations in which the magnetic strip has been subject to a magnetic field which destroys the information on the magnetic strip. Rather, it is useful those situations in which the magnetic strip is dirty. As can be appreciated, by enhancing the ability of card readers to read dirty, unreadable, magnetic strips, cashier errors can be substantially reduced, reducing the occurrence of charges being applied to someone else's card.

In one variation of the invention, rather than inserting the card in the card holder 10, the card can be laminated, so that at least the back side of the card (and the magnetic strip of the card) will be enclosed or encased by the laminate. The laminate can be, for example, a plastic, such as a polyethylene. In this instance, the card can simply be swiped through the card reader—the laminate will prevent the magnetic strip from becoming dirty and unreadable. The laminate preferably has a thickness substantially similar to the thickness of the card holder lower section (i.e., about 0.4-0.8 mils).

As various changes could be made in the above constructions without departing from the scope of the invention, it is intended that all matter contained in the above description or shown in the accompanying drawings shall be interpreted as illustrative and not in a limiting sense. For example, although the card holder 10 is shown to have three sealed sides and to be open at the top, the card holder could instead have top and bottom seams, and one or both sides of the holder could be opened to allow for the card to be slid into the holder. Additionally, the card holder could be provided with only a single film which covers the magnetic strip side of the card, and then have grooved thicker sections at the top and bottom to apply the card holder to the card. The back surface of the card holder could also be made of a different or thicker plastic to which the plastic film is applied. In this situation, the card would be inserted in the holder such that the magnetic strip is against the plastic film side of the holder. These examples are merely illustrative.

We claim:

1. An apparatus for assisting magnetic strip readers in reading cards having a magnetic strip, the apparatus comprising:
front and back panels joined together along at least two edges to form a card holder having an opening between said front and back panels through which the card can pass;
said front and back panels each having a first section and a second section, said first section being sized to extend from a point near the bottom of said panels to a point above the magnetic strip of the card when the card is received in the holder;
said first section having a thickness of between about 0.0004″ to about 0.0008″;
said second section having a thickness sufficient to rigidize the holder enough to enable the holder to be opened by squeezing together opposite sides of said second section.

2. The apparatus of claim 1 wherein said second section has a thickness of about 0.004″ to about 0.008″.

3. The apparatus of claim 1 wherein said first section is made from a film of high density polyethylene.

4. An apparatus for assisting magnetic strip readers in reading cards having a magnetic strip, the apparatus comprising:
front and back panels joined together along at least two edges to form a card holder having an opening between said front and back panels through which the card can pass;
at least a portion of said front panel comprising a plastic film section, said plastic film section being sized and positioned such that when a card having a magnetic strip is inserted in the apparatus, the magnetic strip will be in register with the plastic film.

5. The apparatus of claim 4 wherein the plastic film is a high density polyethylene film.

6. The apparatus of claim 4 wherein the plastic film has a thickness of between about 0.0004″ to about 0.0008″.

7. The apparatus of claim 4 wherein said plastic film portion extends from near a bottom of said front panel to a point above the magnetic strip of the card when the card is received in the holder

8. The apparatus of claim 7 including an upper section above said film portion, said upper section being thicker than said film portion, said upper section having a thickness sufficient to rigidize the holder enough to enable the holder to be opened by squeezing together opposite sides of said second section.

9. The apparatus of claim 8 wherein said upper section has a thickness of about 0.004″ to about 0.008″.

10. A method of enhancing the ability of a magnetic strip reader to read a magnetic strip of a card; the method comprising the steps of:
covering the magnetic strip of the card with a plastic film; and
passing the card in the card holder through the magnetic strip reader.

11. The method of claim 10 wherein the step of covering the magnetic strip with a plastic film comprises:
providing a card holder, the card holder comprising a panel having a plastic film sized and positioned on said panel to cover at least the magnetic strip of the card; and
applying said card holder to the card such that the magnetic strip faces and is in register with said plastic film; and

12. The method of claim 10 wherein said plastic film is a high density polyethylene.

13. The method of claim 10 wherein said plastic film has a thickness of between about 0.0004″ to about 0.0008″.

14. The method of claim 11 wherein said card holder comprises a backing and said plastic film being adhered to said backing along at least two edges of said film; said step of applying card holder to the card comprising opening said card holder and inserting said card between said plastic film and said backing.
